(19) United States
(12) Patent Application Publication
(10) Pub. No.: US 2017/0171585 A1
(43) Pub. Date: Jun. 15, 2017

(54) Method and Electronic Device for Recording Live Streaming Media

(71) Applicants: Le Holdings (Beijing) Co., Ltd., Beijing (CN); LE SHI INTERNET INFORMATION & TECHNOLOGY CORP., BEIJING, Beijing (CN)

(72) Inventor: Yutao Chen, Beijing (CN)

(21) Appl. No.: 15/241,043

(22) Filed: Aug. 18, 2016

Related U.S. Application Data
(63) Continuation of application No. PCT/CN2016/089536, filed on Jul. 10, 2016.

(30) Foreign Application Priority Data
Dec. 15, 2015 (CN) 2015109378123

(51) Int. Cl. H04N 21/274; H04N 21/231; G06F 17/30; H04N 21/433; H04N 21/472; H04N 21/2187; H04N 21/443

(52) U.S. Cl. CPC H04N 21/274; H04N 21/2187; H04N 21/231; H04N 21/4431; H04N 21/433; H04N 21/472; H04N 21/4334; G06F 17/3002; G06F 17/30058

(57) ABSTRACT

The present application relates to the communications field, and discloses a method and electronic device for recording live streaming media. The method includes: sending a live streaming media request to a live server; the live server returning in response to the live streaming media request, a reply to determine existence of live streaming media to be played or being played; sending an application programming interface (API) of a storage server to the live server in response to the reply; and the live server delivering data of the live streaming media to the storage server through the API. According to embodiments of the present application, storage of live streaming media is implemented by storing the live streaming media played by a live server through a storage server, and a user can obtain the stored live streaming media from the storage server by a terminal.

### CROSS-REFERENCE TO RELATED APPLICATIONS

The present application is a continuation of PCT application No. PCT/CN2016/089536 submitted on Jul. 10, 2016, and claims priority to Chinese Patent Application No. 201510937812.3, filed with the Chinese Patent Office on Dec. 15, 2015, and entitled “METHOD AND SYSTEM FOR RECORDING LIVE STREAMING MEDIA,” which is incorporated herein by reference in its entirety.

### TECHNICAL FIELD

The present disclosure relates to the communications field, and specifically, to a method and electronic device for recording live streaming media.

### BACKGROUND

There are mainly two solutions to transmit multimedia information such as audio/video or the like on a network: download and streaming transmission. Generally, audio and video files are larger, and therefore, the required storage capacities are also larger. In addition, because of limitations of network bandwidth, download usually takes several minutes or even several hours, and therefore, such a processing method also causes a great delay. During streaming transmission, time-based media such as sounds, images, or animations, etc., are transmitted continuously in real time by an audio and video server to a user terminal. A user does not have to wait until an entire file is completely downloaded and instead can watch only after a start delay of several seconds or about ten seconds. Streaming media refers to continuous time-based media that uses streaming transmission technologies in a network, for example, an audio, a video, or a multimedia file.

Rapid development and popularization of Internet provide great market driving forces for development of streaming media services, and the streaming media services are becoming popular increasingly. Streaming media technologies are widely used for various aspects of Internet information service such as multimedia press release, online live telecasting, network advertising, E-commerce, video on demand, distance learning, telemedicine, network station, and real-time video conference, etc.

Real-time streaming transmission is used for providing real-time streaming media or live streaming media, and requires ensuring that media signal bandwidth matches with a network connection, so that the media can be watched in real time. The real-time streaming transmission is always real-time delivery, particularly suitable for an onsite event, and also supports a random access, so that a user can fast forward or rewind to watch prior or subsequent content. Theoretically, real-time streaming cannot be stopped as soon as played, but actually, a periodic pause may occur. The real-time streaming transmission must match connection bandwidth, which means that image quality of streaming media is poorer when the streaming media is connected with a speed of a modem. Besides, information that is lost because of errors is ignored. Therefore, streaming media quality will also be affected when a network is crowded or has a problem.

In many scenarios, maybe a user cannot or cannot completely watch and listen to live streaming media, or hope to be able to watch and listen to live streaming media that has been played before in the future. For this reason, a method for downloading live streaming media to a user terminal is provided in prior art. However, a data volume of live streaming media is generally larger, especially video streaming media, and a storage space of a user terminal is limited and difficult to meet a download requirement of the live streaming media. In addition, maybe the user terminal cannot keep a continuous network connection needed for downloading the live streaming media, which causes a failure to download the live streaming media.

There is yet no good solution in prior art to the foregoing problem.

### SUMMARY

The present application provides a method and electronic device for recording live streaming media, and the method and the electronic device can allow a user to store live streaming media, so as to play in the future.

On a first aspect, an embodiment of the present application provides a method for recording live streaming media. The method includes: receiving a live streaming media request sent by a terminal; returning, in response to the live streaming media request, a reply to the terminal to determine existence of live streaming media to be played or being played; receiving an application programming interface API of a storage server sent by the terminal in response to the reply; playing the live streaming media, and delivering data of the live streaming media to the storage server through the API.

On a second aspect, an embodiment of the application further provides a non-volatile computer storage medium, which stores computer executable instructions, where the computer executable instructions is used to execute any of the foregoing methods for recording live streaming media of the application.

On a third aspect, an embodiment of the application further provides an electronic device, including: at least one processor; and a memory, where the memory stores a program that can be executed by the at least one processor, and the instructions is executed by the at least one processor, so that the at least one processor can execute any of the foregoing methods for recording live streaming media of the application.

According to the method and electronic device for recording live streaming media provided by an embodiment of the application, storage of live streaming media is implemented by storing the live streaming media played by a live server through a storage server, and a user can obtain the stored live streaming media from the storage server by a terminal.

Other features and advantages of some embodiments of the present application are described in detail in the following part of DETAILED DESCRIPTION.

### BRIEF DESCRIPTION OF THE DRAWINGS

One or more embodiments are exemplarily described by figures corresponding thereto in the accompanying drawings, and the exemplary descriptions do not constitute a limitation on the embodiments. Elements with the same reference numbers in the accompanying drawings represent similar elements. Unless otherwise particularly stated, the figures in the accompanying drawings do not constitute a scale limitation.

FIG. 1 is a flowchart of a method for recording live streaming media according to an embodiment of the present application;

FIG. 2 is a system for recording live streaming media according to an embodiment of the present application; and

FIG. 3 is a schematic structural diagram of hardware of a device for executing a method for recording live streaming media according to an embodiment of the present application.

### DETAILED DESCRIPTION

To make the objectives, technical solutions, and advantages of the application clearer, hereinafter, the technical solutions of the application will be clearly and completely described by implementation manners with reference to the accompanying drawings in the embodiments of the application. Apparently, the described embodiments are a part rather than all of the embodiments of the application.

FIG. 1 is a flowchart of a method for recording live streaming media according to some embodiments of the present application. As shown in FIG. 1, the embodiment provides a method for recording live streaming media. The method includes: S101 receiving a live streaming media request sent by a terminal; S102 returning, in response to the live streaming media request, a reply to the terminal to determine existence of live streaming media to be played or being played; S103 receiving an application programming interface API of a storage server sent by the terminal in response to the reply; and S104 playing the live streaming media, and delivering data of the live streaming media to the storage server through the API.

In an implementation manner, a user can play live streaming media provided by a live server by using a mobile terminal (or a media play terminal). The streaming media may be video media or audio media. In different implementation manners, the live streaming media may be streaming media that has been delivered through broadcast or unicast by the live server, and also may be streaming media to be delivered through broadcast or unicast by the live server in the future. For the latter implementation manner, preferably, a mobile terminal of a user may obtain beforehand information of the streaming media to be delivered by the live server, to facilitate the user to determine whether the streaming media needs to be played or stored.

For live streaming media of interest, a user can obtain the live streaming media by sending a request through a mobile terminal. A reply or a negative reply may be returned to the mobile terminal in response to the request for the live streaming media. The reply may indicate that the live server can provide the live streaming media requested by the mobile terminal; otherwise, the negative relay may indicate that the live server cannot provide the live streaming media requested by the mobile terminal.

After the mobile terminal receives the reply sent by the live server, the user can select an operation on the live streaming media according to will of the user. For example, the live streaming media may be directly played or stored on the mobile terminal, or stored at other place(s), so that later the live streaming media is easily acquired from the place by the mobile terminal. In an implementation manner of the present application, other place(s) is provided to store by setting a storage server. The storage server may be a web disk or a cloud disk, for example, Baidu cloud, DropBox, etc. The user can acquire a storage space of the web disk or the cloud disk by registering, and bind the storage space with a user identity (ID) to access the storage space by various mobile terminals (for example, a cell phone, a notebook computer, or a tablet computer, etc.).

In an implementation manner, a communication connection needs to be established between a server (for example, a live server) and a storage server, so as to store live streaming media that needs to be stored in the storage server. The communication connection is established through an interface. Therefore, first, an interface that can be connected to the storage server needs to be notified to the live server to establish the communication connection. In this implementation manner, various web disks or cloud disks provide such an interface to the user, for example, an application programming interface (API).

In an implementation manner, the mobile terminal can send an API of the storage server to the live server in response to the reply to establish the communication connection between the live server and the storage server. In other implementation manners, if the API of the storage server is unknown to the user or the mobile terminal, the user can send a request to the storage server to obtain the API through the mobile terminal. Specific steps may be: the mobile terminal sending a storage request to the storage server in response to the rely of the live server; the storage server providing the API to the mobile terminal according to the storage request; and after obtaining the API from the storage server, the mobile terminal sending the API provided by the storage server to the live server, so that the live server can establish the communication connection with the storage server through the API. In a preferable implementation manner, the storage server can allocate a storage space to the live streaming media according to the storage request, for example, allocating the storage space to the live streaming media according to information contained in the storage request, such as a bit rate, a duration, a resolution and the like of the live streaming media, so as to optimize storage management.

The following uses a usage scenario in which a smartphone is the terminal and Baidu cloud is the storage server as an example to further describe the method provided in this embodiment. According to the method used in the scenario, first, a user sends a live streaming media request by the smartphone; a reply can be returned, in response to the live streaming media request, to the smartphone to determine existence of the live streaming media to be played or being played, and this process can be implemented by a live streaming media server; next, the smartphone sends, according to an application programming interface API provided by the pre-bound Baidu cloud, the application programming interface API of the Baidu cloud in response to the reply; at last, the live streaming media is played, and meanwhile data of the live streaming media is delivered to the Baidu cloud to store though the API. In this way, an entire process from the smart phone's request to the Baidu cloud's storing the live streaming media is implemented.

By means of the foregoing implementation manners, data of broadcast or unicast live streaming media of a live server can be directly delivered to a storage server and stored by the storage server without passing through a mobile terminal. Therefore, a storage space of the mobile terminal and network bandwidth can be saved. A user can acquire the live streaming media that has been stored from the storage server by the mobile terminal if necessary. In the implementation manners, after the live server delivers the data of the live streaming media to the storage server through the API, the method may further include: the mobile terminal requesting the data of the live streaming media from the storage server; and the mobile terminal playing the live streaming media acquired from the storage server.

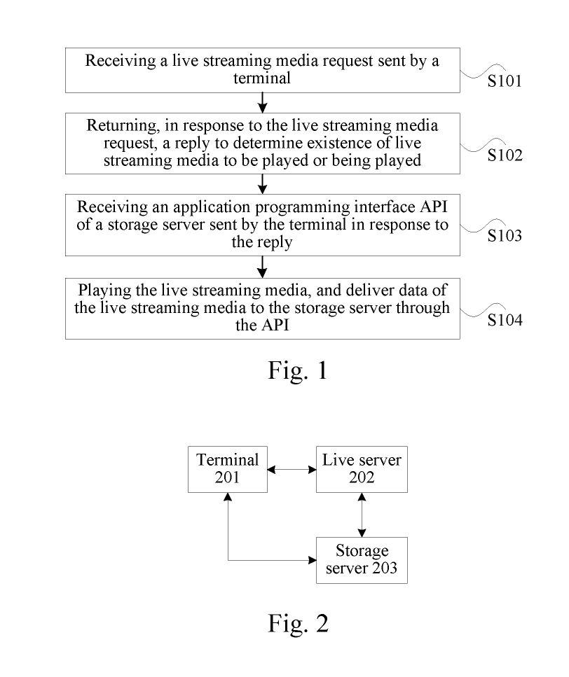

FIG. 2 is a system for recording live streaming media according to an implementation manner of the present application. As shown in FIG. 2, the system for recording live streaming media provided in the implementation manners of the present application may adapt to execute the method provided in the foregoing various implementation manners of the present application. The system may include: a terminal (or a mobile terminal) 201 configured to send a live streaming media request to a live server 202; and the live server 202 configured to return, in response to the live streaming media request, a reply to determine existence of the live streaming media to be played or being played, where the terminal 201 is configured to send an application programming interface (API) of a storage server 203 to the live server 202 in response to the reply; and the live server 202 is configured to deliver data of the live streaming media to the storage server 203 through the API when playing the live streaming media.

In an implementation manner, the live server may be a server owned or operated by a content provider. An example of the terminal may be a device having a display/screen and connected to a network in a wired and/or wireless manner, such as a television, a tablet computer, or a smartphone, etc.

In an implementation manner, the terminal 201 may send a request to obtain the live streaming media. The live server 202 may return a reply or a negative reply to the terminal 201 in response to the request for the live streaming media. The reply may indicate that the live server 202 can provide the live streaming media requested by the terminal 201; otherwise, the negative reply may indicate that the live server 202 cannot provide the live streaming media requested by the terminal 201.

After the terminal 201 receives the reply sent by the live server, the live streaming media may be directly played or stored on the terminal 201, or stored at other place(s) to facilitate the terminal 201 later to acquire the live streaming media from the place. In an implementation manner of the present application, the storage server 203 is configured to provide other place(s) to store. The storage server 203 may be a web disk or a cloud disk, for example, Baidu cloud, DropBox, etc. A system user can acquire a storage space of the web disk or the cloud disk by registering, and bind the storage space with a user identity (ID) to access the storage space by various mobile terminals (for example, a cell phone, a notebook computer, or a tablet computer, etc.).

In an implementation manner, a communication connection needs to be established between the live server 202 and the storage server 203, to store live streaming media that needs to be stored in the storage server 203. The communication connection is established through an interface. Therefore, first, an interface that can be connected to the storage server 203 needs to be notified to the live server 202 to establish the communication connection. In the implementation manner, various web disks or cloud disks provide such an interface to each registered user, for example, an application programming interface (API).

By means of the foregoing technical solution, storage of live streaming media is implemented by storing the live streaming media played by a live server through a storage server, and a user can obtain the stored live streaming media from the storage server by a terminal.

An embodiment of the application provides a non-volatile computer storage medium, which stores computer executable instructions, where the computer executable instructions can execute the method for recording live streaming media of any of the foregoing method embodiments of the application.

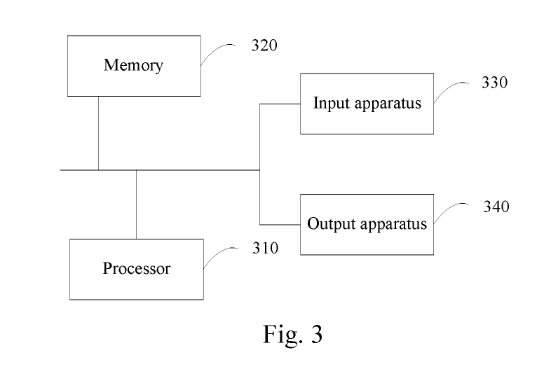

FIG. 3 is a schematic structural diagram of hardware of an electronic device for executing a method for recording live streaming media provided by an embodiment of the application. As shown in FIG. 3, the electronic device includes:

one or more processors 310 and a memory 320, with one processor 310 as an example in FIG. 3.

A device for executing the method for recording live streaming media may further include: an input apparatus 330 and an output apparatus 340.

The processor 310, the memory 320, the input apparatus 330, and the output apparatus 340 can be connected by means of a bus or in other manners, with a connection by means of a bus as an example in FIG. 3.

As a non-volatile computer readable storage medium, the memory 320 can be used to store non-volatile software programs, non-volatile computer executable programs and modules, for example, program instructions/module corresponding to the method for recording live streaming media in the embodiments of the application, where for example the program instructions is configured to execute a method for recording live streaming media, including: receiving a live streaming media request sent by a terminal; returning, in response to the live streaming media request, a reply to the terminal to determine existence of live streaming media to be played or being played; receiving an application programming interface API of a storage server sent by the terminal in response to the reply; and playing the live streaming media, and delivering data of the live streaming media to the storage server through the API. The processor 310 executes various functional applications and data processing of the server, that is, implements the method for recording live streaming media of the foregoing method embodiments, by running the non-volatile software programs, instructions, and modules stored in the memory 320.

The memory 320 may include a program storage area and a data storage area, where the program storage area may store an operating system and at least one application needed by function; the data storage area may store data created by use of the apparatus for recording live streaming media, and the like. In addition, the memory 320 may include a high-speed random access memory, and also may include a non-volatile memory, such as at least one disk storage device, flash storage device, or other non-volatile solid-state storage devices. In some embodiments, the memory 320 optionally includes memories remotely disposed with respect to the processor 310, and the remote memories may be connected, via a network, to the apparatus for recording live streaming media. Examples of the foregoing network include but are not limited to: the Internet, an intranet, a local area network, a mobile communications network, and a combination thereof.

The input apparatus 330 can receive entered digit or character information, and generate key signal inputs relevant to user setting and functional control of the apparatus for recording live streaming media. The output apparatus 340 may include a display device, for example, a display screen, etc.

The one or more modules are stored in the memory 320, and execute the method for recording live streaming media in any one of the foregoing method embodiments when being executed by the one or more processors 310.

The foregoing product can execute the method provided in the embodiments of the application, and has corresponding functional modules for executing the method and beneficial effects. The method provided in the embodiments of the application can be referred to for technical details that are not described in detail in the embodiment.

The electronic device in the embodiment of the application exists in multiple forms, including but not limited to:

(1) Mobile communication device: such devices being characterized by having a mobile communication function and a primary objective of providing voice and data communications; such type of terminals including a smart phone (for example, an iPhone), a multimedia mobile phone, a feature phone, a low-end mobile phone, and the like;

(2) Ultra mobile personal computer device: such devices belonging to a category of personal computers, having computing and processing functions, and also generally a feature of mobile Internet access; such type of terminals including PDA, MID and UMPC devices, and the like, for example, an iPad;

(3) Portable entertainment device: such devices being capable of display and play multimedia content; such type of devices including an audio and video player (for example, an iPod), a handheld game console, an e-book, an intelligent toy and a portable vehicle-mounted navigation device;

(4) Server: a device that provides a computing service; the components of the server including a processor, a hard disk, a memory, a system bus, and the like; an framework of the server being similar to that of a general-purpose computer, but higher demanding in aspects of processing capability, stability, reliability, security, extensibility, manageability or the like due to a need to provide highly reliable services; and

(5) Other electronic apparatuses having a data interaction function.

The apparatus embodiments described above are merely schematic, and the units described as separated components may or may not be physically separated; components presented as units may or may not be physical units, that is, the components may be located in one place, or may be also distributed on multiple network units. Some or all modules therein may be selected according to an actual requirement to achieve the objective of the solution of the embodiment.

Through descriptions of the foregoing implementation manners, a person skilled in the art can clearly recognize that each implementation manner can be implemented by means of software in combination with a general-purpose hardware platform, and certainly can be also implemented by hardware. Based on such an understanding, the essence or a part contributing to the relevant technologies of the foregoing technical solutions can be embodied in the form of a software product. The computer software product may be stored in a computer readable storage medium, for example, a ROM/RAM, a magnetic disk, a compact disc or the like, including several instructions for enabling a computer device (which may be a personal computer, a sever, or a network device, and the like) to execute the method described in the embodiments or in some parts of the embodiments.

Finally, it should be noted that the foregoing embodiments are only for the purpose of describing the technical solutions of the application, rather than limiting thereon. Although the application has been described in detail with reference to the foregoing embodiments, a person of ordinary skill in the art should understand that he/she can still modify technical solutions disclosed in the foregoing embodiments, or make equivalent replacements to some technical features therein, while such modifications or replacements do not make the essence of corresponding technical solutions depart from the spirit and scope of the technical solutions of the embodiments of the application.

What is claimed is:

1. A method for recording live streaming media applied in an electronic device, comprising:
receiving a live streaming media request sent by a terminal;
returning, in response to the live streaming media request, a reply to the terminal to determine existence of live streaming media to be played or being played;
receiving an application programming interface API of a storage server sent by the terminal in response to the reply; and
playing the live streaming media, and delivering data of the live streaming media to the storage server through the API.

2. The method according to claim 1, wherein the terminal sending an API of a storage server in response to the reply comprises:
the terminal sending a storage request to the storage server in response to the reply, so that the storage server provides the API according to the storage request; and
sending the API.

3. The method according to claim 2, wherein the method further comprises:
the storage server allocating a storage space to the live streaming media according to the storage request.

4. The method according to claim 1, wherein after the delivering data of the live streaming media to the storage server through the API, the method further comprises:
the terminal requesting the data of the live streaming media from the storage server; and
the terminal playing the live streaming media acquired from the storage server.

5. The method according to claim 2, wherein after the delivering data of the live streaming media to the storage server through the API, the method further comprises:
the terminal requesting the data of the live streaming media from the storage server; and
the terminal playing the live streaming media acquired from the storage server.

6. The method according to claim 3, wherein after the delivering data of the live streaming media to the storage server through the API, the method further comprises:
the terminal requesting the data of the live streaming media from the storage server; and
the terminal playing the live streaming media acquired from the storage server.

7. The method according to claim 1, wherein the storage server is a web disk or a cloud disk.

8. The method according to claim 2, wherein the storage server is a web disk or a cloud disk.

9. The method according to claim 3, wherein the storage server is a web disk or a cloud disk.

10. The method according to claim 4, wherein the storage server is a web disk or a cloud disk.

11. A non-volatile computer storage medium, stored with computer executable instructions, where the computer executable instructions is configured for:
receiving a live streaming media request sent by a terminal;
returning to the terminal, in response to the live streaming media request, a reply to determine existence of live streaming media to be played or being played,
receiving an application programming interface API of a storage server sent by the terminal in response to the reply;
playing the live streaming media and delivering data of the live streaming media to the storage server through the API.

12. The non-volatile computer storage medium according to claim 11, wherein
the terminal is configured to send a storage request to the storage server in response to the reply;
the storage server is configured to provide the API to the terminal according to the storage request; and
the terminal is configured to send the API provided by the storage server to the live server.

13. The non-volatile computer storage medium according to claim 12, wherein the storage server is configured to allocate a storage space to the live streaming media according to the storage request.

14. The non-volatile computer storage medium according to claim 11, wherein the terminal is configured to:
request the data of the live streaming media from the storage server; and
play the live streaming media acquired from the storage server.

15. The non-volatile computer storage medium according to claim 12, wherein the terminal is configured to:
request the data of the live streaming media from the storage server; and
play the live streaming media acquired from the storage server.

16. The non-volatile computer storage medium according to claim 13, wherein the terminal is configured to:
request the data of the live streaming media from the storage server; and
play the live streaming media acquired from the storage server.

17. The non-volatile computer storage medium according to claim 11, wherein the storage server is a web disk or a cloud disk.

18. An electronic device, including:
at least one processor; and
a memory in communication connection with the at least one processor, where the memory stores instructions that can be executed by the at least one processor, and the instructions is executed by the at least one processor, so that the at least one processor is capable of:
receiving a live streaming media request sent by a terminal;
returning, in response to the live streaming media request, a reply to the terminal to determine existence of live streaming media to be played or being played;
receiving an application programming interface API of a storage server sent by the terminal in response to the reply; and
playing the live streaming media, and delivering data of the live streaming media to the storage server through the API.

19. The electronic device according to claim 12, wherein
the terminal is configured to send a storage request to the storage server in response to the reply,
the storage server is configured to provide the API for the terminal according to the storage request; and
the terminal is configured to send the API provided by the storage server to the live server.

20. The electronic device according to claim 19, wherein the storage server is configured to allocate a storage space to the live streaming media according to the storage request.
